(19) United States
(12) Patent Application Publication
(10) Pub. No.: US 2016/0215169 A1
(43) Pub. Date: Jul. 28, 2016

(54) Water Repellent Liquid, Water Repellent Article, and Method for Manufacturing the Same

(71) Applicant: Central Glass Company, Limited, Ube-shi (JP)

(72) Inventors: Hiroshi NOMURA, Matsusaka-shi (JP); Shigeo HAMAGUCHI, Matsusaka-shi (JP)

(21) Appl. No.: 15/001,664

(22) Filed: Jan. 20, 2016

(30) Foreign Application Priority Data
Jan. 22, 2015 (JP) 2015-010114
Feb. 23, 2015 (JP) 2015-032632
Jun. 30, 2015 (JP) 2015-131266
Oct. 8, 2015 (JP) 2015-200045

(51) Int. Cl. C09D 183/08; C03C 17/30

(52) U.S. Cl. CPC C09D 183/08; C03C 17/30; C03C 2218/11; C03C 2217/78; C03C 2217/76

(57) ABSTRACT

A water repellent liquid for forming water repellent film. The liquid is provided containing: fluoroalkylsilane compound represented by general formula 1

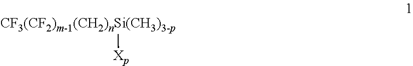

where “m” is an integer between 2 and 7, “n” is an integer between 1 and 5, “X” is mutually independently at least one group selected from the group consisting of alkoxy group, chloro group, isocyanate group and hydroxyl group, and “p” is an integer between 1 and 3; silicon compound represented by general formula 2

R¹₂SiY₂ 2
where “R¹” mutually independently represents a C₁-C₂₀ hydrocarbon group, “Y” mutually independently represents at least one group selected from the group consisting of alkoxy group, chloro group, isocyanate group and hydroxyl group, and “R¹” may be a branched hydrocarbon group or a cyclic hydrocarbon group; organic solvent; water; and acid. In this liquid the mass ratio of the fluoroalkylsilane compound to the silicon compound is between 1:0.1 and 1:20.

### BACKGROUND OF THE INVENTION

This invention relates to improvements in: a water repellent liquid used for forming a water repellent film on various kinds of base materials; a water repellent article obtained by using the water repellent liquid; and a method for manufacturing the same.

Water repellent glasses having water repellency exhibit the property of rejecting raindrops in the event of rain thereby contributing to the maintenance of good visibility either indoors or outdoors or both. Hence the water repellent glasses are used in wide variety of fields such as architectures, vehicles, shipboards and aircraft. In particular, water repellent glasses having good water sliding property where waterdrops can easily slide are excellent in raindrop removability, so that the operating safety in the event of rain can dramatically be improved. Accordingly, water repellent glasses having both good water sliding property and durability enough for actual use are desired. Moreover, a water repellent material excellent in water sliding property also has the effect of reducing ice accretion or snow accretion and therefore expected to be a water repellent article for use in electric wires in snowbelt areas or for use in outdoor antennas.

In recent years, fluoroalkylsilane compounds having large fluorocarbon units (the total number of CF₃ and CF₂), and more specifically, those having not less than eight fluorocarbon units (hereinafter, such fluoroalkylsilane compounds may sometimes be referred to as “long-chain fluoroalkylsilane compounds”) have been found to have a fear that PFOA (perfluorooctanoic acid) formed as a by-product during the synthesizing process puts a significant burden on the environment. Hence EPA (United States Environmental Protection Agency) announced in April 2003 that they would make eager scientific investigations of PFOA, and a condition of long-chain fluoroalkylsilane compounds being not easily available has continued ever since.

On the other hand, there has been known a relationship between the number of fluorocarbon units in a fluoroalkylsilane compound and its water repellency or water sliding property; for example, the smaller number of fluorocarbon units brings about the reduction of rigidity of the compound to make the units and therefore tends to have difficulty in orderly aligning on the surface of the base material. Such a tendency is particularly outstandingly demonstrated when the number of fluorocarbon units is not more than seven, in which case the water repellency and water sliding property may reduce as a result.

Consequently, there has intensely been desired: a water repellent film having durability while having the same water repellency and water sliding property as those of long-chain fluoroalkylsilane compounds even if a fluoroalkylsilane compound the number of fluorocarbon units of which is not more than seven; and a treatment agent which can form the water repellent film.

Patent Document 1 describes a water repellent film having great abrasion resistance in which (3,3,4,4,5,5,6,6,7,7,8,8,8-tridecafluorooctyl)triethoxysilane (i.e., a fluoroalkylsilane compound the number of fluorocarbon units of which is six) is used.

Patent Document 2 mentions that an organic/inorganic transparent hybrid film formed by polycondensation between (3,3,4,4,5,5,6,6,7,7,8,8,8-tridecafluorooctyl)triethoxysilane (i.e., a fluoroalkylsilane compound the number of fluorocarbon units of which is six) and tetramethoxysilane etc. is small in difference (hysteresis) between advancing and receding contact angles and therefore good in water sliding property.

### REFERENCES ABOUT PRIOR ART

Patent Document 1: Japanese Patent Application Publication No. 2014-043552

Patent Document 2: Japanese Patent Application Publication No. 2013-213181

### SUMMARY OF THE INVENTION

However, drawbacks have been encountered in the above discussed conventional water repellent film. More specifically, the water repellent film of Patent Document 1 is susceptible to improvement in water sliding property (as will be discussed in Comparative Example 8) and the water repellent film of Patent Document 2 is insufficient particularly in abrasion resistance (as will be discussed in Comparative Example 10). Thus a water repellent film that accomplishes both properties is strongly desired.

In view of the above, an object of the present invention is to provide: a water repellent liquid which contains a fluoroalkylsilane compound the number of fluorocarbon units of which is not more than seven and which is able to form a water repellent film accomplishing both good water sliding property and good abrasion resistance; a water repellent article obtained by using the water repellent liquid; and a method for manufacturing the same.

As a result of having eagerly made studies in view of the above problems, the present inventors found that a water repellent film having good water sliding property and abrasion resistance can be obtained by incorporating a specified silicon compound into a water repellent liquid together with a specified fluoroalkylsilane compound the fluorocarbon units of which is 2 to 7, an organic solvent, water and an acid catalyst at a specified mixing ratio, thereby attaining the present invention.

A first aspect of the present invention resides in a water repellent liquid for forming a water repellent film, comprising: a fluoroalkylsilane compound represented by the general formula [1]

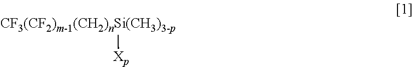

where “m” is an integer between 2 and 7, “n” is an integer between 1 and 5, “X” is mutually independently at least one group selected from the group consisting of alkoxy group, chloro group, isocyanate group and hydroxyl group, and “p” is an integer between 1 and 3; a silicon compound represented by the general formula [2]

R¹₂SiY₂ [2]

where “R¹” mutually independently represents a C₁-C₂₀ hydrocarbon group, “Y” mutually independently represents at least one group selected from the group consisting of alkoxy group, chloro group, isocyanate group and hydroxyl group, and “R¹” may be a branched hydrocarbon group or a cyclic hydrocarbon group; an organic solvent; water; and acid, wherein the mass ratio of the fluoroalkylsilane compound to the silicon compound is between 1:0.1 and 1:20.

Concerning the water repellent liquid of the first aspect of the present invention, it is preferable that, in the silicon compound represented by the general formula [2], “R¹” mutually independently represents a C₁-C₅ hydrocarbon group and “Y” mutually independently represents alkoxy group.

Concerning the water repellent liquid of the first aspect of the present invention, it is preferable that, in the silicon compound represented by the general formula [2], “R¹” mutually independently represents a C₁-C₃ hydrocarbon group and “Y” mutually independently represents at least one group selected from the group consisting of methoxy group, ethoxy group and propoxy group.

Concerning the water repellent liquid of the first aspect of the present invention, it is preferable that the mass ratio between the fluoroalkylsilane compound represented by the general formula [1] and the silicon compound represented by the general formula [2] ranges from 1:0.1 to 1:10.

Concerning the water repellent liquid of the first aspect of the present invention, it is preferable that the acid comprises an organic sulfonic acid.

Concerning the water repellent liquid of the first aspect of the present invention, it is preferable that, in the fluoroalkylsilane compound represented by the general formula [1], “m” is an integer between 2 and 7, “n” is an integer between 1 and 3, “X” mutually independently represents alkoxy group, and “p” is 3.

Concerning the water repellent liquid of the first aspect of the present invention, it is preferable that, in the fluoroalkylsilane compound represented by the general formula [1], “m” is an integer between 4 and 6, “n” is an integer between 1 and 3, “X” mutually independently represents alkoxy group, and “p” is 3.

A second aspect of the present invention resides in a water repellent liquid for forming a water repellent film, comprising: a fluoroalkylsilane compound represented by the general formula [1-A]

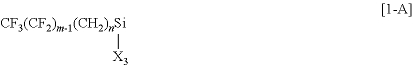

where “m” is an integer between 4 and 6, “n” is an integer between 1 and 3, “X” mutually independently represents alkoxy group; a silicon compound represented by the general formula [2-A]

R¹₂SiY2 [2-A]

where “R¹” mutually independently represents a C₁-C₃ hydrocarbon group, “Y” mutually independently represents at least one group selected from the group consisting of methoxy group, ethoxy group and propoxy group, and “R¹” may be a branched hydrocarbon group or a cyclic hydrocarbon group; an organic solvent; water; and an organic sulfonic acid, wherein the mass ratio of the fluoroalkylsilane compound to the silicon compound is between 1:0.1 and 1:10.

Concerning the water repellent liquid of the second aspect of the present invention, it is preferable that the number of moles of the organic sulfonic acid is 0.1 to 13 times the total number of moles of the fluoroalkylsilane compound represented by the general formula [1-A] and the silicon compound represented by the general formula [2-A], while the number of moles of water is 0.1 to 130 times the total number of moles of the fluoroalkylsilane compound represented by the general formula [1-A] and the silicon compound represented by the general formula [2-A].

A third aspect of the present invention resides in a water repellent film comprising: a partial hydrolysis polycondensation product formed between the fluoroalkylsilane compound represented by the general formula [1-A] and the silicon compound represented by the general formula [2-A].

A fourth aspect of the present invention resides in a method for manufacturing a water repellent article including a base material and a water repellent film formed on the base material, comprising the steps of: applying the above-mentioned water repellent liquid onto a surface of a base material thereby forming a water repellent film.

Concerning the manufacturing method of the fourth aspect of the present invention, it is preferable that the method further comprises the steps of: performing heat treatment after the liquid application, at 50 to 350° C. for 1 to 60 minutes.

Concerning the manufacturing method of the fourth aspect of the present invention, it is preferable that a means for applying the above-mentioned water repellent liquid onto the surface of the base material is hand coating.

Concerning the manufacturing method of the fourth aspect of the present invention, it is preferable that the water repellent film has a film thickness of less than 10 nm and not less than 1 nm.

Concerning the manufacturing method of the fourth aspect of the present invention, it is preferable that the base material is formed of glass.

According to the present invention, it is possible to form a water repellent film attaining both great water sliding property and abrasion resistance by using a water repellent liquid containing a fluoroalkylsilane compound the number of fluorocarbon units of which is 2 to 7.

### DETAILED DESCRIPTION OF THE INVENTION

Hereinafter, an embodiment of the present invention will specifically be discussed; however, the present invention is not limited to the following embodiment, and modifications and variations of the embodiment will occur to those skilled in the art in light of the teachings of the invention.

<Fluoroalkylsilane Compound>

In a water repellent liquid according to the present invention, there is used a fluoroalkylsilane compound represented by the following general formula [1];

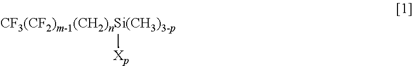

where “m” (i.e. the total number of CF₃ and CF₂) is an integer between 2 and 7, “n” is an integer between 1 and 5, “X” is mutually independently at least one group selected from the group consisting of alkoxy group, chloro group, isocyanate group and hydroxyl group, and “p” is an integer between 1 and 3.

When “m”, the number of fluorocarbon units (i.e. the total number of CF₃ and CF₂) is increased, a water repellent film obtained is to be improved in weather resistance and abrasion resistance. However, as discussed in BACKGROUND OF THE INVENTION, fluoroalkylsilane compounds having a large number “m” has been under a condition of being not easily available. Meanwhile, in fluoroalkylsilane compounds having a small number “m”, the fluoroalkylsilane chain is so short as to make the water repellent film insufficient in water repellency and abrasion resistance (as will be discussed in Comparative Example 17). In view of the above, an integer between 2 and 7 is given as “m”.

Usable examples of a fluoroalkylsilane compound represented by the general formula [1] include CF₃(CF₂)₅CH₂CH₂Si(OCH₃)₃, CF₃(CF₂)₅CH₂CH₂Si(OC₂H₅)₃, CF₃(CF₂)₅CH₂CH₂SiCH₃(OCH₃)₂, CF₃(CF₂)₅CH₂CH₂Si(CH₃)₂OCH₃, CF₃(CF₂)₃CH₂CH₂Si(OCH₃)₃, CF₃(CF₂)₃CH₂CH₂SiCH₃(OCH₃)₂, CF₃(CF₂)₃CH₂CH₂Si(CH₃)₂OCH₃, CF₃(CF₂)₅CH₂CH₂SiCl₃, CF₃(CF₂)₅CH₂CH₂SiCH₃Cl₂, CF₃(CF₂)₅CH₂CH₂Si(CH₃)₂Cl, CF₃(CF₂)₃CH₂CH₂SiCl₃, CF₃(CF₂)₃CH₂CH₂SiCH₃Cl₂, CF₃(CF₂)₃CH₂CH₂Si(CH₃)₂Cl and the like. From the viewpoint of availability and durability in a water repellent article or a water repellent film to be obtained, it is preferable to employ a fluoroalkylsilane compound represented by the general formula [1] where “m” is an integer between 4 and 6 and/or “n” is an integer between 1 and 3.

In the general formula [1], “X” may be an alkoxy group such as methoxy group, ethoxy group, propoxy group, isopropoxy group and butoxy group, or chloro group or isocyanate group or hydroxyl group. However, if the reactivity of these functional groups is excessively high, the compound not only becomes difficult to handle in preparing the water repellent liquid but also possibly shortens the pot life of the water repellent liquid. Meanwhile, if the reactivity is excessively poor, the reaction cannot adequately be developed, so that the amount of silanol groups to be formed is not obtained sufficiently. Hence a bond between the base material and the water repellent film to be obtained becomes weakened thereby possibly causing reduction of weather resistance and abrasion resistance of the water repellent film. With consideration given to ease of handling, pot life of the water repellent film and weather resistance and abrasion resistance of the water repellent film to be obtained, it is preferable that “X” is an alkoxy group, more preferably methoxy group or ethoxy group among the above-mentioned examples. Moreover, though the number of functional group “X” which is reactive with the base material is defined between 1 and 3 per molecule, it is preferably three because the larger number of “X” strengthens the bond between the base material and the water repellent film to be obtained or improves durability.

In the case where a base material to which the water repellent liquid is to be applied is a glass, the fluoroalkylsilane compound represented by the general formula [1] is adapted to have, at its one end, a functional group “X” reactive with a silanol group that resides on the surface of the glass base material. If the water repellent liquid contains a fluoroalkylsilane compound having such a functional group respectively at both ends, the fluoroalkylsilane compound tends to become redundant after the water repellent liquid is applied to the glass base material and then dried. The redundant content is apt to firmly adhere to the glass base material to be difficult to remove after drying. Accordingly, it is preferable to use a fluoroalkylsilane compound having a functional group reactive with a silanol group only at one end.

Furthermore, the amount of the fluoroalkylsilane compound to be added is preferably 1 to 20 mass % relative to the total amount of the water repellent liquid. When the amount is less than 1 mass %, initial water repellency (or initial contact angle), weather resistance and abrasion resistance are significantly lowered. Meanwhile if the amount exceeds 20 mass %, not only handling property in preparing the water repellent liquid and pot life of the water repellent liquid are reduced but also the cost of the water repellent liquid is increased. Accordingly, it is preferable that the amount of addition of the fluoroalkylsilane compound is 1 to 20 mass %.

<Silicon Compound>

A silicon compound to be used in the water repellent liquid of the present invention is a silicon compound represented by the following general formula [2]:

R¹₂SiY₂ [2]

where “R¹” mutually independently represents a C₁-C₂₀ hydrocarbon group, “Y” mutually independently represents at least one group selected from the group consisting of alkoxy group, chloro group, isocyanate group and hydroxyl group, and “R¹” may be a branched hydrocarbon group or a cyclic hydrocarbon group.

When a base material has on its surface a water repellent film where the fluoroalkylsilane compounds are closely arranged, fluorocarbon groups are to serve as the outermost surface of the water repellent film; however, the fluorocarbon groups are considered to have a little mobility (or flexibility) or considered to be poor in force for rolling (or driving) waterdrops. In view of the above, there is conceived a method of increasing the distance between fluorocarbon groups thereby improving the mobility of the fluorocarbon groups and heightening the waterdrop-rolling force, as a method of enhancing the water sliding property of the water repellent film.

The above-mentioned silicon compound is employed as a component to be put between molecules of the fluoroalkylsilane compound as a spacer at the time of forming the water repellent film in the use of the water repellent liquid in order to increase the distance between fluorocarbon groups of the fluoroalkylsilane compound thereby enhancing the mobility of the fluorocarbon groups. Since the mobility of the fluorocarbon groups is thus improved, the water sliding property of the formed water repellent film is improved as compared with the case of not using the silicon compound.

As a spacer for increasing the distance between fluorocarbon groups of the fluoroalkylsilane compound, there can be conceived tetraalkoxysilane having no inactive group (such as TMOS) and alkyltrialkoxysilane having one inactive group (such as MTES), in addition to the above-mentioned silicon compound having two inactive groups (R¹). However, when the water repellent film is formed by hand coating method using these silanes, it is difficult to obtain good appearance and evenness because a SiO₂ layer is unevenly formed. Such a film exhibits a high haze value and whitish and therefore sometimes not preferably accepted (as will be discussed in Comparative Examples 1 and 2).

Moreover, in the case where trialkylalkoxysilane (such as trimethylethoxysilane) having three inactive groups is employed, adhesiveness between the spacer and glass becomes inadequate so that the abrasion resistance tends to become insufficient (as will be discussed in Comparative Example 6).

Usable examples of the silicon compound represented by the general formula [2] are dimethyldimethoxysilane, dimethyldiethoxysilane, diethyldimethoxysilane, diethyldiethoxysilane, dimethyldichlorosilane, dimethyldiisocyanatesilane, vinylmethyldimethoxysilane, di-n-butyldimethoxysilane, octadecylmethyldiethoxysilane, cyclohexylmethyldimethoxysilane and the like.

The silicon compound used in the water repellent liquid of the present invention is preferably represented by the above-shown general formula [2] where “R¹” is mutually independently a C₁-C₅ hydrocarbon group and “Y” mutually independently represents alkoxy group. Concrete examples thereof include dimethyldimethoxysilane, dimethyldiethoxysilane, diethyldimethoxysilane, diethyldiethoxysilane, vinylmethyldimethoxysilane, di-n-butyldimethoxysilane and the like.

The silicon compound used in the water repellent liquid of the present invention is preferably represented by the above-shown general formula [2] where “R¹” is mutually independently a C₁-C₃ hydrocarbon group and “Y” mutually independently represents at least one group selected from the group consisting of methoxy group, ethoxy group and propoxy group. Concrete examples thereof include dimethyldimethoxysilane, dimethyldiethoxysilane, diethyldimethoxysilane, diethyldiethoxysilane, vinylmethyldimethoxysilane and the like.

<Mass Ratio Between the Components>

In the water repellent liquid according to the present invention, the mass ratio between the fluoroalkylsilane compound and the silicon compound is 1:0.1 to 1:20, preferably 1:0.1 to 1:10, and much more preferably 1:0.1 to 1:6. If the mass ratio falls short of 1:0.1, the silicon compound cannot easily exhibit its function as a spacer and the fluoroalkylsilane compound cannot obtain a sufficient mobility (flexibility), and therefore the water sliding property is hardly improved. Meanwhile, if the mass ratio gets larger than 1:20, the abrasion resistance becomes easily be reduced.

<Organic Solvent>

In the water repellent liquid according to the present invention, it is possible to use an organic solvent which can dissolve the fluoroalkylsilane compound and an acid catalyst. Preferable examples of the organic solvent are: lower alcohols such as ethyl alcohol and isopropyl alcohol; ketones such as methyl ethyl ketone and methyl isobutyl ketone; esters such as ethyl acetate and butyl acetate; hydrocarbon solvents such as hexane, toluene, benzene and xylene; ethers such as diethyl ether and diisopropyl ether; and mixtures of these. It is also possible to employ fluorine-containing solvents such as hydrofluorocarbons, perfluorocarbons, perfluoroethers and hydrofluoroethers. Of the above, lower alcohols such as isopropyl alcohol are particularly preferable because these can excellently dissolve the fluoroalkylsilane compound and an acid catalyst and make the coating property (or ease of application) and the drying time (or operation time) of the water repellent liquid moderate.

Furthermore, the amount of the organic solvent to be added is preferably 80 to 99 mass %, more preferably 90 to 99 mass % relative to the total amount of the water repellent liquid. When the amount of the organic solvent is less than 80 mass %, the amount of the water repellent liquid to be adhered to the base material is increased excessively so as to degrade the coating property (or ease of application) of the water repellent liquid. Meanwhile if the amount of the organic solvent exceeds 99 mass %, the amount of the water repellent liquid to be adhered to the base material is too decreased to provide water repellency and water sliding property sufficiently.

<Water>

Water is used in the water repellent liquid of the present invention to serve as a component for causing hydrolysis and polycondensation reaction between the fluoroalkylsilane compound and the silicon compound at least partially. The amount of water to be added, in terms of the number of moles, is preferably 0.1 to 130 times, more preferably 3 to 30 times the total number of moles of the fluoroalkylsilane compound and the silicon compound. If the amount of water is less than 0.1 times the total number of moles of the fluoroalkylsilane compound and the silicon compound, hydrolysis and polycondensation reaction are hardly developed in the water repellent liquid. Since it is difficult to bond a sufficient amount of the fluoroalkylsilane compound and the silicon compound to the base material, water repellency and water sliding property may not be provided sufficiently. Meanwhile, if the amount of water exceeds 130 times the total number of moles of the fluoroalkylsilane compound and the silicon compound, hydrolysis and polycondensation reaction are so promptly developed in the water repellent liquid as to easily shorten the pot life. Additionally, in order to adjust the water content in the water repellent liquid, a dehydration treatment may be performed for a certain period of time by adding a dehydrating agent to the water repellent liquid. As the dehydrating agent, it is possible to use silica gel, synthetic zeolite, activated alumina and the like; however, the dehydrating agent is not limited to these examples.

<Acid>

Acid to be used in the water repellent liquid according to the present invention is a component for accelerating polycondensation reaction between the fluoroalkylsilane compound and the silicon compound, and either inorganic acid or organic acid is adoptable. Of various acids, organic sulfonic acids are preferably used because these tend to impart good abrasion resistance to the water repellent film.

Examples of organic sulfonic acids which may be used in the water repellent liquid are: methanesulfonic acid, ethanesulfonic acid, propanesulfonic acid, 2-propanesulfonic acid, butanesulfonic acid, 2-butanesulfonic acid, nonafluoro-1-butanesulfonic acid, pentanesulfonic acid, torifluoromethanesulfonic acid, 2-hydroxyethane-1-sulfonic acid, 2-hydroxypropane-1-sulfonic acid, 2-hydroxybutane-1-sulfonic acid, 2-hydroxypentanesulfonic acid, 1-carboxyethanesulfonic acid, 1,3-propanedisulfonic acid, arylsulfonic acid, 1-sulfoacetic acid, 2- or 3-sulfopropionic acid, benzenesulfonic acid, p-toluenesulfonic acid, xylenesulfonic acid, nitrobenzenesulfonic acid, sulfobenzoic acid, sulfosalicylic acid, benzaldehydesulfonic acid, p-phenolsulfonic acid, phenol-2,4-disulfonic acid, and the like. Of these examples, methanesulfonic acid, ethanesulfonic acid and p-toluenesulfonic acid are readily available and particularly preferable from the viewpoint of the safety (or volatilization resistance) and the ease of handling (or hygroscopic resistance).

The amount of acid to be added, in terms of the number of moles, is preferably 0.1 to 13 times, more preferably 0.1 to 7 times the total number of moles of the fluoroalkylsilane compound and the silicon compound. If the amount of acid is less than 0.1 times the total number of moles of the fluoroalkylsilane compound and the silicon compound, polycondensation reaction is hardly developed in the water repellent liquid. Since it is difficult to bond a sufficient amount of the fluoroalkylsilane compound and the silicon compound to the base material, water repellency and water sliding property may not be provided sufficiently. Meanwhile, if the amount of acid exceeds 13 times the total number of moles of the fluoroalkylsilane compound and the silicon compound, the polycondensation reaction is so promptly developed in the water repellent liquid as to easily shorten the pot life.

<Method of Preparing Water Repellent Liquid>

Then, a preferable method for preparing a water repellent liquid according to the present invention will be discussed.

A water repellent liquid is obtained by adding water and acid to a mixture of a fluoroalkylsilane compound represented by the general formula [1], a silicon compound represented by the general formula [2] and an organic solvent, and then mixing it, followed by causing polycondensation between the fluoroalkylsilane compound and the silicon compound. The reason why the fluoroalkylsilane compound and the silicon compound and the organic solvent are previously mixed is in order to mix the fluoroalkylsilane compound and the silicon compound homogenously with each other. However, the above raw materials may be mixed simultaneously.

<Method for Manufacturing Water Repellent Article>

Then, there will be discussed a method for manufacturing a water repellent article in use of the water repellent liquid obtained by the above-mentioned manner.

A coating method for applying the thus obtained water repellent liquid to the surface of the base material is exemplified by hand coating, flow coating using a nozzle, dip coating, spray coating, reverse roll coating, flexography, print processes, flow coating, spin coating, roll coating, and suitable combinations thereof. Of these coating methods, hand coating is preferably employed in that: the coating efficiency is so excellent as to suppress the coating loss; the cost for introducing a coating facility can be reduced; and it is possible to form a film of a nm-order thickness, the film being so clear as to make scratches unremarkable. Incidentally, “hand coating” mentioned in the present invention refers to a technical means of applying a coating liquid onto a base material by at least one means selected from a means for supplying a coating liquid to a member and then bringing the member into contact with a base material and a means for supplying a coating liquid to a base material and then spreading the liquid by a member. The member to which a coating liquid is supplied or the member for spreading a coating liquid on a base material is exemplified by cloth, paper, nonwoven fabric, gauze, sponge, felt and the like. The means for bringing a coating liquid-supplied member into contact with a base material or a means for spreading a coating liquid by a member is exemplified by those by human hand, robot and machine.

In the method of manufacturing the water repellent article according to the present invention it is preferable to carry out heat treatment at 50 to 350° C. for 1 to 60 minutes after liquid application, in which a base material onto which the water repellent liquid is applied is not particularly limited insofar as it has a heat-resistant temperature higher than the heating temperature. For example, it is possible to employ a float plate glass commonly used for vehicle windows or architectural windows, or a transparent inorganic plate glass such as soda-lime glass produced by roll forming method. Reflective materials such as mirrors, semitransparent to opaque glass materials such as ground glass and pattern-inscribed glass, obtained by using the above-mentioned plate glasses are usable.

In addition to the above-mentioned glass base materials, it is also possible to employ base materials formed of; ceramic material used for tiles, roofing tiles, sanitary potteries, eating utensils and the like, metal material such as stainless steel, aluminum and steel, used for frame members for glass window, cookwares, medical instruments such as scalpels and needles, sink, automotive bodies and the like; plastic base material such as polycarbonate resin, polyethylene terephthalate resin, polymethyl methacrylate resin, polyethylene resin, polyvinyl chloride resin and the like.

Additionally, a treatment for improving adhesive strength between the base material and the water repellent film may previously be conducted on the surface of the base material. The treatment is exemplified by treatments for generating active groups on the surface of the substrate, such as polishing, rinsing and drying with the use of various polishing liquids, a surface reforming treatment using an acid or basic solution, a primer treatment, plasma radiation, corona discharge, high-pressure mercury lamp irradiation and the like. In particular, a primer treatment performed by applying a solution to which a silicon compound having four functional groups is added onto a base material is preferable because the silicon compound is bonded to the base material while silanol groups (or active groups) are formed derived from the silicon compound thereby allowing previously increasing the number of silanol groups on the surface onto which the water repellent liquid is to applied.

Then, a treatment to be conducted after applying the water repellent liquid to the base material will be discussed. After applying the water repellent liquid to the base material, heating is preferably conducted at 50 to 350° C. for 1 to 60 minutes. With this, a silanol group derived from “X” of the fluoroalkylsilane compound is more firmly bonded to a bondable group (such as hydroxyl group) which resides on the surface of the base material than in the case of not performing heat treatment, so that it becomes possible to form on the surface of the base material a solid film (a water repellent layer) accomplishing excellent durability and more particularly accomplishing both weather resistance and abrasion resistance. Heat treatment may be performed under atmospheric pressure, applied pressure or reduced pressure or in inert atmosphere.

Since a redundant content is apt to finally remain in the form of a dried hardened matter on the base material, the redundant content is wiped off with a paper towel or cloth moistened with an organic solvent and/or a dried paper towel or cloth, thereby obtaining an article on which the water repellent film is formed.

### EXAMPLES

Referring now to Examples, the present invention will specifically be discussed. Water repellent articles obtained by the undermentioned Examples and Comparative Examples were subjected to a quality evaluation as will be explained below. The water repellent articles obtained by the undermentioned Examples and Comparative Examples had such a construction as to form a water repellent film all over the surface of one side of a glass base material. However, the invention is not limited to these examples.

[Outward Appearance]

The outward appearance of the water repellent article was visually checked. An article having no apparent problem such as film unevenness, crack, color and the like at its water repellent film was regarded as passing the test and given a denotation “A” in Table 1, while an article having any apparent problem was regarded as not passing the test and given a denotation “B”.

[Film Thickness]

The water repellent film formed on the base material was partially cut away to gain a stepwise section between the water repellent film and the base material. The stepwise section was subjected to measurement by using a high-precision microfigure measuring instrument available from Kosaka Laboratory Ltd. under the trade name of SURFCORDER ET 4000A, thereby obtaining the film thickness of the film.

[Contact Angle (Or Water Repellency) of Water Repellent Article]

Pure water in an amount of about 2 μl was put on the water repellent film of the water repellent article, and then an angle formed between the waterdrop and the surface of the sample was measured in the atmosphere (at a temperature of about 25° C.) by using a DM-501 model of a contact angle meter available from a Kyowa Interface Science Co., LTD. An article having an initial contact angle of 105° or greater was regarded as passing the test and given a denotation “A” in Table 1, while an article having an initial contact angle of lower than 105° was regarded as being insufficient in performance and given a denotation “B”.

[Sliding Angle (Or Water Sliding Property) of Water Repellent Article]

Pure water in an amount of 50 μl was put dropwise on the surface of the sample in the condition of being kept horizontal. Then, the sample was gradually inclined, and an inclination angle at which the waterdrop started sliding was determined as a sliding angle (°). Incidentally, the sliding angle was measured in the atmosphere (at a temperature of about 25° C.) by using a DM-501 model of a contact angle meter available from a Kyowa Interface Science Co., LTD. An article having smaller sliding angle was regarded as being greater in water sliding property. An initial performance of a sliding angle of not larger than 15° was classified as acceptable and given a denotation “A” in Table 1, while that of not smaller than 16° was regarded as non-acceptable (or as being insufficient in performance) and given a denotation “B”.

[Abrasion Resistance of Water Repellent Article]

Two kinds and seven kinds of powdery dust for JIS (Japanese

Industrial Standard) test were mixed at a ratio of 2:1 by weight and then diluted up to twelve parts of water thereby preparing a dust liquid. Then 2 cc of the dust liquid was dropped on the water repellent article, followed by conducting a traverse test thereon. Subsequently, a contact angle (°) was measured under the conditions as follows to evaluate the water repellent article.

Test machine: Traverse sliding test machine

Size of sample: About 200 mm square

Friction element: Weather strip (length: 100 mm)

Load: 70 g/cm

Repetitions of test: 3000 Reciprocations

An article having a contact angle of waterdrop of not smaller than 80° after the test was regarded as passing the test and given a denotation “A” in Table 1, while that of smaller than 80° was regarded as being insufficient in performance and classified as non-acceptable (a denotation “B”).

### Example 1

(Preparation of Application Liquid)

A mixture of 1.0 g of (3,3,4,4,5,5,6,6,7,7,8,8,8-tridecafluorooctyl)triethoxysilane fluoroalkyltrialkoxysilane the number of fluorocarbon units of which is six) and 0.5 g of dimethyldimethoxysilane and 37 g of isopropyl alcohol was prepared and stirred for about 5 minutes. Then, 0.34 g of methanesulfonic acid (MS) and 0.24 g of water were added to the above-mentioned mixture and stirred for 2 hours at room temperature, thereby obtaining an application liquid where the ratio of fluoroalkylsilane to dimethyldimethoxysilane was 1:0.5 (wt %) and the solid content was 3.8 wt %.

(Preparation of Base Material)

A surface of a float glass plate of 10 cm square, having a thickness of 3.0 mm, was sufficiently polished with cerium oxide. Thereafter the glass plate was rinsed with purified water and then dried, thereby preparing a base material.

(Production of Water Repellent Article)

The prepared application liquid in an amount of 1.0 ml was added dropwise onto the glass base material and then spread adequately over the whole surface of the glass base material by using cotton (available under the trade name of BEMCOT), followed by being dried in wind for about 5 minutes. Then, the glass base material was put into an electric furnace to be subjected to 10 minutes of heat treatment. At this time the glass base material had a temperature (or a heat treatment temperature) of 150° C. at the maximum. Finally, a redundant water-repellent content that had remained on the glass like a white brindled pattern was wiped off with a paper towel moistened with isopropyl alcohol, thereby obtaining a clear sample having no problem at least by visual observation.

As a result of performing quality evaluation according to the above-discussed method, the sliding angle was given “A” (13°) and therefore regarded as exhibiting a good water sliding property. Moreover, the contact angle (109°) and the abrasion resistance (102°) were given “A” and therefore regarded as exhibiting good water repellency and abrasion resistance, respectively.

### Examples 2 to 19 and Comparative Examples 1 to 17

The procedures of Example 1 were repeated with the exception that the kind of the fluoroalkylsilane compound, the kind of the silicon compound, the mass ratio of the fluoroalkylsilane compound to the silicon compound, the kind of the acid, the added amount of the acid to be added, the amount of water to be added and the film-formation method were modified.

### Example 20

The procedures of Example 13 were repeated with the exception that heat treatment was not performed after drying in wind.

Incidentally, the amount of the acid to be added means how many times greater number of moles of acid was added than the sum of the numbers of moles of the fluoroalkylsilane compound and the silicon compound. Likewise, the amount of water to be added means how many times greater number of moles of water was added than the sum of the numbers of moles of the fluoroalkylsilane compound and the silicon compound.

Indications given in Table 1 as C1FAS, C4FAS, C6FAS, C8FAS and C10FAS denote fluoroalkylsilane compounds, and more specifically, [CF₃CH₂CH₂Si(OCH₃)₃], [CF₃(CF₂)₃CH₂CH₂Si(OCH₃)₃], [CF₃(CF₂)₅CH₂CH₂Si(OCH₂CH₃)₃], [CF₃(CF₂)₇CH₂CH₂Si(OCH₃)₃] and [CF₃(CF₂)₉CH₂CH₂Si(OCH₃)₃], respectively. Moreover, an indication “MS” in the column of acid means methanesulfonic acid and “5N nitric acid” means nitric acid the normality of which is 5.

Concerning each Examples and Comparative Examples, its components in the water repellent liquid and the ratio among the components are shown in the following Table 1. Additionally, there are also shown in the following Table 1 the film thickness, the result of checking outward appearance, the sliding angle, the initial contact angle of water, and the result of measuring abrasion resistance.

TABLE 1

| | Water repellent liquid | | | | | | | |
|---|---|---|---|---|---|---|---|---|
| | | Silicon compound (Y) | | | | | | |
| | | | | Number of | | Acid | | Water |
| | Fluoroalkyl | | Number of | carbons in | | | Added | Added |
| | silane | | inactive | inactive | | | amount | amount |
| | (X) | Kind | groups | group | X:Y (wt %) | Kind | (molar ratio) | (molar ratio) |
| Example 1 | C6FAS | Dimethyldimethoxysilane | 2 | 1.1 | 1:0.5 | MS | 0.75 | 3 |
| Example 2 | C6FAS | Dimethyldimethoxysilane | 2 | 1.1 | 1:1 | MS | 0.75 | 3 |
| Example 3 | C6FAS | Dimethyldimethoxysilane | 2 | 1.1 | 1:0.2 | MS | 0.75 | 3 |
| Example 4 | C6FAS | Dimethyldimethoxysilane | 2 | 1.1 | 1:5.0 | MS | 0.75 | 3 |
| Example 5 | C6FAS | Dimethyldimethoxysilane | 2 | 1.1 | 1:7.0 | MS | 0.75 | 3 |
| Example 6 | C6FAS | Dimethyldiethoxysilane | 2 | 1.1 | 1:0.5 | MS | 0.75 | 3 |
| Example 7 | C6FAS | Vinylmethyldimethoxysilane | 2 | 2.1 | 1:0.5 | MS | 0.75 | 3 |
| Example 8 | C6FAS | Di-n- | 2 | 4.4 | 1:0.5 | MS | 0.75 | 3 |
| | | butyldimethoxysilane | | | | | | |
| Example 9 | C6FAS | Cyclohexylmethyldimethoxysilane | 2 | 6.1 | 1:0.5 | MS | 0.75 | 3 |
| Example 10 | C6FAS | Octadecylmethyldiethoxysilane | 2 | 18.1 | 1:0.5 | MS | 0.75 | 3 |
| Example 11 | C6FAS | Dimethyldimethoxysilane | 2 | 1.1 | 1:0.5 | 5N | 0.75 | 3 |
| | | | | | | Nitric acid | | |
| Example 12 | C6FAS | Di-n- | 2 | 4.4 | 1:0.5 | 5N | 0.75 | 3 |
| | | butyldimethoxysilane | | | | Nitric acid | | |
| Example 13 | C6FAS | Dimethyldimethoxysilane | 2 | 1.1 | 1:1 | MS | 0.75 | 12 |
| Example 14 | C6FAS | Dimethyldimethoxysilane | 2 | 1.1 | 1:1 | MS | 0.75 | 0.5 |
| Example 15 | C6FAS | Dimethyldimethoxysilane | 2 | 1.1 | 1:1 | MS | 0.75 | 100 |
| Example 16 | C6FAS | Dimethyldimethoxysilane | 2 | 1.1 | 1:1 | MS | 0.25 | 12 |
| Example 17 | C6FAS | Dimethyldimethoxysilane | 2 | 1.1 | 1:1 | MS | 10 | 12 |
| Example 18 | C6FAS | Dimethyldimethoxysilane | 2 | 1.1 | 1:1 | MS | 5 | 50 |
| Example 19 | C4FAS | Dimethyldimethoxysilane | 2 | 1.1 | 1:1 | MS | 0.75 | 12 |
| Example 20 | C6FAS | Dimethyldimethoxysilane | 2 | 1.1 | 1:1 | MS | 0.75 | 12 |
| Comparative | C6FAS | Tetramethoxysilane | 0 | — | 1:0.5 | MS | 0.75 | 3 |
| Example 1 | | | | | | | | |
| Comparative | C6FAS | Methyltriethoxysilane | 1 | 1 | 1:0.5 | MS | 0.75 | 3 |
| Example 2 | | | | | | | | |
| Comparative | C6FAS | Propyltrimethoxysilane | 1 | 3 | 1:0.5 | MS | 0.75 | 3 |
| Example 3 | | | | | | | | |
| Comparative | C6FAS | Hexyltrimethoxysilane | 1 | 5 | 1:0.5 | MS | 0.75 | 3 |
| Example 4 | | | | | | | | |
| Comparative | C6FAS | Decyltrimethoxysilane | 1 | 10 | 1:0.5 | MS | 0.75 | 3 |
| Example 5 | | | | | | | | |
| Comparative | C6FAS | Trimethylmethoxysilane | 3 | 1.1.1 | 1:0.5 | MS | 0.75 | 3 |
| Example 6 | | | | | | | | |
| Comparative | C6FAS | Dimethyldimethoxysilane | 2 | 1.1 | 1:25 | MS | 0.75 | 3 |
| Example 7 | | | | | | | | |
| Comparative | C6FAS | — | — | | — | MS | 0.75 | 3 |
| Example 8 | | | | | | | | |
| Comparative | — | Dimethyldimethoxysilane | 2 | 1.1 | — | MS | 0.75 | 3 |
| Example 9 | | | | | | | | |
| Comparative | C6FAS | Tetramethoxysilane | 0 | — | 1:0.5 | MS | 0.75 | 3 |
| Example 10 | | | | | | | | |
| Comparative | Hexyltriethoxysilane | Tetramethoxysilane | 0 | — | 1:0.5 | MS | 0.75 | 3 |
| Example 11 | | | | | | | | |
| Comparative | C6FAS | Dimethyldimethoxysilane | 2 | 1.1 | 1:1 | MS | 0.75 | 0 |
| Example 12 | | | | | | | | |
| Comparative | C6FAS | Dimethyldimethoxysilane | 2 | 1.1 | 1:1 | MS | 0 | 12 |
| Example 13 | | | | | | | | |
| Comparative | C6FAS | Dimethyldimethoxysilane | 2 | 1.1 | 1:1 | MS | 0 | 0 |
| Example 14 | | | | | | | | |
| Comparative | C8FAS | Dimethyldimethoxysilane | 2 | 1.1 | 1:1 | MS | 0.75 | 12 |
| Example 15 | | | | | | | | |
| Comparative | C10FAS | Dimethyldimethoxysilane | 2 | 1.1 | 1:1 | MS | 0.75 | 12 |
| Example 16 | | | | | | | | |
| Comparative | C1FAS | Dimethyldimethoxysilane | 2 | 1.1 | 1:1 | MS | 0.75 | 12 |
| Example 17 | | | | | | | | |

| | Water | | | | | | | | |
|---|---|---|---|---|---|---|---|---|---|
| | repellent | | | | | | | | |
| | liquid | Water repellent article | | | | | | | |
| | Film | Film | | Sliding angle | | Contact angle | | Abrasion resistance | |
| | formation | thickness | Outward | | Result | | Result | | Result |
| | method | (nm) | appearance | Evaluation | (°) | Evaluation | (°) | Evaluation | (°) |
| Example 1 | Hand coating | Smaller than | A | A | 13 | A | 109 | A | 102 |
| | | 10 | | | | | | | |
| Example 2 | Hand coating | Smaller than | A | A | 11 | A | 109 | A | 98 |
| | | 10 | | | | | | | |
| Example 3 | Hand coating | Smaller than | A | A | 11 | A | 108 | A | 95 |
| | | 10 | | | | | | | |
| Example 4 | Hand coating | Smaller than | A | A | 11 | A | 107 | A | 101 |
| | | 10 | | | | | | | |
| Example 5 | Hand coating | Smaller than | A | A | 15 | A | 107 | A | 91 |
| | | 10 | | | | | | | |
| Example 6 | Hand coating | Smaller than | A | A | 15 | A | 108 | A | 98 |
| | | 10 | | | | | | | |
| Example 7 | Hand coating | Smaller than | A | A | 14 | A | 105 | A | 96 |
| | | 10 | | | | | | | |
| Example 8 | Hand coating | Smaller than | A | A | 12 | A | 108 | A | 101 |
| | | 10 | | | | | | | |
| Example 9 | Hand coating | Smaller than | A | A | 13 | A | 105 | A | 90 |
| | | 10 | | | | | | | |
| Example 10 | Hand coating | Smaller than | A | A | 15 | A | 107 | A | 85 |
| | | 10 | | | | | | | |
| Example 11 | Hand coating | Smaller than | A | A | 13 | A | 109 | A | 85 |
| | | 10 | | | | | | | |
| Example 12 | Hand coating | Smaller than | A | A | 13 | A | 107 | A | 81 |
| | | 10 | | | | | | | |
| Example 13 | Hand coating | Smaller than | A | A | 8 | A | 108 | A | 101 |
| | | 10 | | | | | | | |
| Example 14 | Hand coating | Smaller than | A | A | 15 | A | 108 | A | 100 |
| | | 10 | | | | | | | |
| Example 15 | Hand coating | Smaller than | A | A | 11 | A | 108 | A | 100 |
| | | 10 | | | | | | | |
| Example 16 | Hand coating | Smaller than | A | A | 13 | A | 108 | A | 100 |
| | | 10 | | | | | | | |
| Example 17 | Hand coating | Smaller than | A | A | 13 | A | 108 | A | 100 |
| | | 10 | | | | | | | |
| Example 18 | Hand coating | Smaller than | A | A | 11 | A | 108 | A | 100 |
| | | 10 | | | | | | | |
| Example 19 | Hand coating | Smaller than | A | A | 8 | A | 108 | A | 86 |
| | | 10 | | | | | | | |
| Example 20 | Hand coating | Smaller than | A | A | 8 | A | 108 | A | 91 |
| | | 10 | | | | | | | |
| Comparative | Hand coating | — | B (Whitely | — | — | — | — | — | — |
| Example 1 | | | clouded) | | | | | | |
| Comparative | Hand coating | — | B (Whitely | — | — | — | — | — | — |
| Example 2 | | | clouded) | | | | | | |
| Comparative | Hand coating | Smaller than | A | B | 21 | A | 108 | B | 41 |
| Example 3 | | 10 | | | | | | | |
| Comparative | Hand coating | Smaller than | A | B | 20 | A | 108 | B | 39 |
| Example 4 | | 10 | | | | | | | |
| Comparative | Hand coating | Smaller than | A | B | 19 | A | 109 | B | 45 |
| Example 5 | | 10 | | | | | | | |
| Comparative | Hand coating | Smaller than | A | B | 16 | A | 109 | B | 48 |
| Example 6 | | 10 | | | | | | | |
| Comparative | Hand coating | Smaller than | A | A | 13 | B | 101 | B | 32 |
| Example 7 | | 10 | | | | | | | |
| Comparative | Hand coating | Smaller than | A | B | 20 | A | 110 | A | 101 |
| Example 8 | | 10 | | | | | | | |
| Comparative | Hand coating | Smaller than | A | A | 10 | B | 99 | B | 41 |
| Example 9 | | 10 | | | | | | | |
| Comparative | Spin coating | 100 | A | B | 16 | B | 104 | B | 65 |
| Example 10 | | | | | | | | | |
| Comparative | Spin coating | 100 | A | A | 14 | B | 95 | B | 30 |
| Example 11 | | | | | | | | | |
| Comparative | Hand coating | Smaller than | A | B | 16 | A | 106 | A | 100 |
| Example 12 | | 10 | | | | | | | |
| Comparative | Hand coating | Smaller than | A | B | 22 | B | 78 | — | — |
| Example 13 | | 10 | | | | | | | |
| Comparative | Hand coating | Smaller than | A | B | 30 | B | 70 | — | — |
| Example 14 | | 10 | | | | | | | |
| Comparative | Hand coating | Smaller than | A | B | 16 | A | 109 | A | 98 |
| Example 15 | | 10 | | | | | | | |
| Comparative | Hand coating | Smaller than | A | B | 17 | A | 110 | A | 92 |
| Example 16 | | 10 | | | | | | | |
| Comparative | Hand coating | Smaller than | A | B | 19 | B | 97 | B | 30 |
| Example 17 | | 10 | | | | | | | |

As shown in Table 1, water repellent liquids of Examples 1 to 20 contained a fluoroalkylsilane compound represented by the general formula [1], a silicon compound represented by the general formula [2], an organic solvent, water and acid, in which the mass ratio of the fluoroalkylsilane compound to the silicon compound ranged between 1:0.1 and 1:20. Water repellent articles produced from these water repellent liquids exhibited good water sliding property and good abrasion resistance. In addition, these water repellent articles were also excellent in outward appearance and initial contact angle.

Water repellent articles of Examples 1 and 8 using an organic acid (more specifically, methanesulfonic acid) were found to be superior in abrasion resistance to those of Examples 11 and 12 using an inorganic acid (more specifically, nitric acid).

Water repellent articles of Examples 1 and 8 in which the number of carbons in inactive group of the silicon compound represented by the general formula [2] was small were found to be superior in abrasion resistance to those of Examples 9 and 10 in which the number of carbons was large.

A water repellent article of Example 13 using a fluoroalkylsilane compound where the value of “m” in a fluorocarbon unit represented by CF₃(CF₂)ₘ₋₁ was six was found to be superior in abrasion resistance to that of Example 19 where the value of “m” was four.

The water repellent article of Example 13 on which heat treatment was conducted at 150° C. for 10 minutes was found to be superior in abrasion resistance to that of Example 20 on which heat treatment was not conducted.

### Comparative Example 1

The procedures of Example 1 were repeated with the exception that tetramethoxysilane (i.e., a silicon compound where the number of inactive group (R¹) was zero) was used instead of dimethyldimethoxysilane, thereby obtaining a water repellent article. However, coating unevenness at least by hand coating was observed, and additionally it was found that silicon compounds caused polycondensation therebetween in a drying step to deposit a silica component on the surface of the glass to whitely cloud the film.

### Comparative Example 2

The procedures of Example 1 were repeated with the exception that methyltriethoxysilane (i.e., a silicon compound where the number of inactive group (R¹) was one) was used instead of dimethyldimethoxysilane, thereby obtaining a water repellent article. However, it was observed that the film was whitely clouded.

### Comparative Examples 3 to 5

The procedures of Example 1 were repeated with the exception of using silicon compounds where the number of inactive group (R¹) was one while the number of carbons in inactive group was 3 to 10 instead of dimethyldimethoxysilane, thereby obtaining a water repellent article. Though the film was obtained with good appearance and transparency, it was found insufficient in water sliding property and abrasion resistance.

### Comparative Example 6

The procedures of Example 1 were repeated with the exception of using a silicon compound where the number of inactive group (R¹) was three instead of dimethyldimethoxysilane, thereby obtaining a water repellent article. However, the article was found to be insufficient in water sliding property. Furthermore, the number of inactive group was large and the adhesion to the glass base material was poor, so that the abrasion resistance was inadequate.

### Comparative Example 7

The procedures of Example 1 were repeated with the exception that the mass ratio between the fluoroalkylsilane compound and the silicon compound was modified into 1:25 (wt %), thereby obtaining a water repellent article. As a result of evaluating this article according to the above-mentioned evaluation method, it was found that the water sliding property was good. However, since the concentration of the fluoroalkylsilane compound on the surface of the film was decreased, the initial contact angle and the abrasion resistance were not enough.

### Comparative Example 8

The procedures of Example 1 were repeated with the exception that dimethyldimethoxysilane was not used, thereby obtaining a water repellent article. However, this article was found to be insufficient in sliding angle because the effect of spacer was not exhibited without the silicon compound.

### Comparative Example 9

The procedures of Example 1 were repeated with the exception that C6FAS was not used, thereby obtaining a water repellent article. Though the water sliding property was enough, the initial contact angle and the abrasion resistance were not enough.

### Comparative Example 10

The procedures of Comparative Example 1 were repeated with the exception that the film was formed by spin coating and not by hand coating, thereby obtaining a water repellent article. Though a water repellent film of 100 nm film thickness was obtained, its water sliding property, initial contact angle and abrasion resistance were not enough. The reason why the water sliding property was not enough is considered because C6FAS and tetraalkoxysilane took on 3-D structure and therefore the effect of spacer could not sufficiently be exhibited. Furthermore, the reason why the initial contact angle and the abrasion resistance were not enough is considered because the concentration of fluoroalkoxysilane on the surface of the film was decreased.

### Comparative Example 11

The procedures of Comparative Example 10 were repeated with the exception that hexyltriethoxysilane, a kind of C6AS (C₆ alkoxysilane), was used instead of C6FAS, thereby obtaining a water repellent article. Though the water sliding property was good, the initial contact angle and the abrasion resistance were not enough.

### Comparative Examples 12 to 14

The procedures of Example 1 were repeated with the exception that acid or water was not used, thereby obtaining a water repellent article. As a result, the water sliding property and the initial contact angle were not enough.

### Comparative Examples 15 and 16

The procedures of Example 13 were repeated with the exception that C8FAS and C10FAS were used instead of C6FAS, thereby obtaining a water repellent article. As a result, the water sliding property was found to be insufficient, which is considered because a fluoroalkylsilane chain is too long and rigid to be improved in flexibility even if using dimethyldimethoxysilane as a spacer.

### Comparative Example 17

The procedures of Example 13 were repeated with the exception that C 1FAS was used instead of C6FAS, thereby obtaining a water repellent article. As a result, its water repellency, abrasion resistance and the like were found to be insufficient, which is considered because a fluoroalkylsilane chain is so short that the fluorine concentration in the water repellent film is low.

### INDUSTRIAL APPLICABILITY

Water repellent glasses having water repellency exhibit the property of rejecting raindrops in the event of rain thereby contributing to the maintenance of good visibility either indoors or outdoors or both. Hence the water repellent glasses are used in wide variety of fields such as architectures, vehicles, shipboards and aircraft. In particular, water repellent glasses having good water sliding property where waterdrops can easily slide are excellent in raindrop removability, so that the operating safety in the event of rain can dramatically be improved. Accordingly, water repellent glasses having both good water sliding property and durability enough for actual use are desired. Moreover, a water repellent material excellent in water sliding property also has the effect of reducing ice accretion or snow accretion and therefore expected to be a water repellent article for use in electric wires in snowbelt areas or for use in outdoor antennas.

Vehicle windows are required to be resistant to abrasion caused by wiper blades to be attached to front or rear windows and abrasion caused when a drainage mall attached to a side door glass is vertically moved. Meanwhile, architectural windows are required to be resistant to wipes at the time of cleaning in use of towels or the like.

The water repellent article according to the present invention accomplishes both good water sliding property and good abrasion resistance, and usable as a vehicle window or an architectural window.

The entire contents of Japanese Patent Application No. 2015-200045 filed Oct. 8, 2015 are herein incorporated by reference. Although the invention has been described above by reference to certain embodiments and examples of the invention, the invention is not limited to the embodiments and examples described above. Modifications and variations of the embodiments and examples described above will occur to those skilled in the art, in light of the above teachings. The scope of the invention is defined with reference to the following claims.

1. A water repellent liquid for forming a water repellent film, comprising:
a fluoroalkylsilane compound represented by the general formula 1 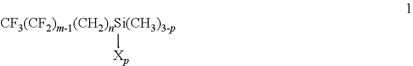
where “m” is an integer between 2 and 7, “n” is an integer between 1 and 5, “X” is mutually independently at least one group selected from the group consisting of alkoxy group, chloro group, isocyanate group and hydroxyl group, and “p” is an integer between 1 and 3;
a silicon compound represented by the general formula 1
R¹₂SiY₂ 2
where “R¹” mutually independently represents a C₁-C₂₀ hydrocarbon group, “Y” mutually independently represents at least one group selected from the group consisting of alkoxy group, chloro group, isocyanate group and hydroxyl group, and “R¹” may be a branched hydrocarbon group or a cyclic hydrocarbon group;
an organic solvent;
water; and
acid,
wherein the mass ratio of the fluoroalkylsilane compound to the silicon compound is between 1:0.1 and 1:20.

2. A water repellent liquid as claimed in claim 1, wherein, in the silicon compound represented by the general formula 2, “R¹” mutually independently represents a C₁-C₅ hydrocarbon group and “Y” mutually independently represents alkoxy group.

3. A water repellent liquid as claimed in claim 1, wherein, in the silicon compound represented by the general formula 2, “R¹” mutually independently represents a C₁-C₃ hydrocarbon group and “Y” mutually independently represents at least one group selected from the group consisting of methoxy group, ethoxy group and propoxy group.

4. A water repellent liquid as claimed in claim 1, wherein the mass ratio between the fluoroalkylsilane compound represented by the general formula 1 and the silicon compound represented by the general formula 2 ranges from 1:0.1 to 1:10.

5. A water repellent liquid as claimed in claim 1, wherein the acid comprises an organic sulfonic acid.

6. A water repellent liquid as claimed in claim 1, wherein, in the fluoroalkylsilane compound represented by the general formula 1, “m” is an integer between 2 and 7, “n” is an integer between 1 and 3, “X” mutually independently represents alkoxy group, and “p” is 3.

7. A water repellent liquid as claimed in claim 1, wherein, in the fluoroalkylsilane compound represented by the general formula 1, “m” is an integer between 4 and 6, “n” is an integer between 1 and 3, “X” mutually independently represents alkoxy group, and “p” is 3.

8. A water repellent liquid for forming a water repellent film, comprising:
a fluoroalkylsilane compound represented by the general formula 1A 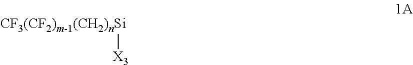
where “m” is an integer between 4 and 6, “n” is an integer between 1 and 3, “X” mutually independently represents alkoxy group;
a silicon compound represented by the general formula 2A
R¹₂SiY₂ 2A
where “R¹” mutually independently represents a C₁-C₃ hydrocarbon group, “Y” mutually independently represents at least one group selected from the group consisting of methoxy group, ethoxy group and propoxy group, and “R¹” may be a branched hydrocarbon group or a cyclic hydrocarbon group;
an organic solvent;
water; and
an organic sulfonic acid,
wherein the mass ratio of the fluoroalkylsilane compound to the silicon compound is between 1:0.1 and 1:10.

9. A water repellent liquid as claimed in claim 8, wherein the number of moles of the organic sulfonic acid is 0.1 to 13 times the total number of moles of the fluoroalkylsilane compound represented by the general formula 1A and the silicon compound represented by the general formula 2A, while the number of moles of water is 0.1 to 130 times the total number of moles of the fluoroalkylsilane compound represented by the general formula 1A and the silicon compound represented by the general formula 2A.

10. A water repellent film comprising:
a partial hydrolysis polycondensation product formed between the fluoroalkylsilane compound represented by the general formula 1A and the silicon compound represented by the general formula 2A.

11. A method for manufacturing a water repellent article including a base material and a water repellent film formed on the base material, comprising the steps of:
applying a water repellent liquid as claimed in claim 1 onto a surface of a base material thereby forming a water repellent film.

12. A method for manufacturing a water repellent article, as claimed in claim 11, further comprising the steps of:
performing heat treatment after the liquid application, at 50 to 350° C. for 1 to 60 minutes.

13. A method for manufacturing a water repellent article, as claimed in claim 11, wherein a means for applying the water repellent liquid as claimed in claim 1 onto the surface of the base material is hand coating.

14. A method for manufacturing a water repellent article, as claimed in claim 11, wherein the water repellent film has a film thickness of less than 10 nm and not less than 1 nm.

15. A method for manufacturing a water repellent article, as claimed in claim 14, wherein the base material is formed of glass.
